(19) United States
(12) Patent Application Publication
(10) Pub. No.: US 2026/0074118 A1
(43) Pub. Date: Mar. 12, 2026

(54) MULTILAYER CERAMIC CAPACITOR

(71) Applicant: Murata Manufacturing Co., Ltd., Nagaokakyo-shi (JP)

(72) Inventors: Tomoki KITAGAWA, Nagaokakyo-shi (JP); Tatsunori YASUDA, Nagaokakyo-shi (JP)

(21) Appl. No.: 19/387,925

(22) Filed: Nov. 13, 2025

Related U.S. Application Data
(63) Continuation of application No. PCT/JP2024/013662, filed on Apr. 2, 2024.

(30) Foreign Application Priority Data
Jul. 19, 2023 (JP) 2023-117709

(51) Int. Cl. H01G 4/232; H01G 2/06; H01G 4/008; H01G 4/012; H01G 4/30

(52) U.S. Cl. CPC H01G 4/232; H01G 2/065; H01G 4/008; H01G 4/012; H01G 4/30

(57) ABSTRACT

A multilayer ceramic capacitor includes a multilayer body including first through sixth surfaces, a first outer electrode on the third, first, second, fifth and sixth surfaces, and a second outer electrode on the fourth, first, second, fifth and sixth surfaces. The first underlying electrode layer includes a first connection portion on the third surface, a first band portion on the first surface, and a third band portion on the second surface. The second underlying electrode layer includes a second connection portion on the fourth surface, a second band portion on the first surface, and a fourth band portion on the second surface. A dimension of the first band portion is larger than a dimension the third band portion in the first underlying electrode layer, and a dimension of the second band portion is larger than a dimension of the fourth band portion in the second underlying electrode layer.

### CROSS REFERENCE TO RELATED APPLICATIONS

This application claims the benefit of priority to Japanese Patent Application No. 2023-117709 filed on Jul. 19, 2023 and is a Continuation Application of PCT Application No. PCT/JP2024/013662 filed on Apr. 2, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

A multilayer ceramic capacitor includes a capacitor main body including a multilayer body in which dielectric layers and inner electrodes are alternately laminated and outer electrodes disposed on the surface of the multilayer body. In the capacitor main body, the inner electrodes are opposite to each other, with the dielectric layer interposed therebetween, to generate electrostatic capacitance. However, vibration occurs in the capacitor main body due to a piezoelectric phenomenon in this case, and a board is vibrated. That is, a phenomenon referred to as so-called “acoustic noise” occurs.

There are known multilayer ceramic capacitors in which, in order to reduce or prevent the occurrence of the “acoustic noise,” a bump covering a portion of an outer electrode is separately disposed on the side mounted on a board in a capacitor main body to reduce the influence of the vibration of the capacitor main body on the board.

For example, U.S. Patent No. 10,542,626 discloses a technique in which the distance between a capacitor main body and a board is set long by bumps (connection terminals) to reduce the influence of vibration and a board material such as alumina having a high rigidity or Young's modulus is used to reduce or prevent the vibration itself.

For example, U.S. Patent No. 10,971,301 discloses a technique in which bumps (spacers) are formed by applying paste for bump formation onto a component main body and executing heat treatment in order to set the distance between a capacitor main body and a board long by the bumps and reduce the influence of vibration.

### SUMMARY OF THE INVENTION

In the technique disclosed in U.S. Patent No. 10,542,626, when the bumps are attached to the capacitor main body later, misalignment to an undesired position or rotation in an undesired orientation sometimes occurs in position alignment with the capacitor main body.

In the technique disclosed in U.S. Patent No. 10,971,301, the bumps are formed by the paste. This allows position adjustment with comparatively desired accuracy concerning position alignment. However, depending on the material of the paste, there is a possibility that a metal component included in an outer electrode of the capacitor main body is simultaneously burned by heat used when the paste is subjected to the heat treatment to be solidified and thus a void is formed and the moisture resistance lowers.

Therefore, example embodiments of the present invention provide multilayer ceramic capacitors that each reduce or prevent the occurrence of “acoustic noise” by the capacitor alone in the multilayer ceramic capacitor.

A multilayer ceramic capacitor according to an example embodiment of the present invention is a multilayer ceramic capacitor including a multilayer body including a first surface and a second surface opposite to each other in a height direction, a third surface and a fourth surface opposite to each other in a first direction orthogonal to the height direction, and a fifth surface and a sixth surface opposite to each other in a second direction orthogonal to the height direction and the first direction, a first outer electrode on the third surface, the first surface, the second surface, the fifth surface, and the sixth surface of the multilayer body, and a second outer electrode on the fourth surface, the first surface, the second surface, the fifth surface, and the sixth surface of the multilayer body. The first outer electrode includes a first underlying electrode layer and a first plated layer on the first underlying electrode layer. The second outer electrode includes a second underlying electrode layer and a second plated layer on the second underlying electrode layer. The first underlying electrode layer includes a first connection portion on the third surface, a first band portion on the first surface, and a third band portion on the second surface. The second underlying electrode layer includes a second connection portion on the fourth surface, a second band portion on the first surface, and a fourth band portion on the second surface. The dimension of the first band portion in the height direction is larger than the dimension of the third band portion in the height direction in the first underlying electrode layer. The dimension of the second band portion in the height direction is larger than the dimension of the fourth band portion in the height direction in the second underlying electrode layer.

In a multilayer ceramic capacitor according to an example embodiment the present invention, the first outer electrode includes the first underlying electrode layer and the first plated layer on the first underlying electrode layer, and the second outer electrode has the second underlying electrode layer and the second plated layer on the second underlying electrode layer. Further, the first underlying electrode layer includes the first connection portion on the third surface, the first band portion on the first surface, and the third band portion on the second surface, and the second underlying electrode layer includes the second connection portion on the fourth surface, the second band portion on the first surface, and the fourth band portion on the second surface. Moreover, the dimension of the first band portion in the height direction is larger than the dimension of the third band portion in the height direction in the first underlying electrode layer, and the dimension of the second band portion in the height direction is larger than the dimension of the fourth band portion in the height direction in the second underlying electrode layer. Therefore, an inner layer portion of the multilayer body is made remote from a mounting board in mounting of the multilayer ceramic capacitor. Thus, the influence of vibration of the multilayer body on the board is reduced, and the “acoustic noise” can be reduced or prevented.

According to example embodiments of the present invention, the occurrence of the “acoustic noise” is reduced or prevented by the capacitor alone in the multilayer ceramic capacitor.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view depicting an example of a multilayer ceramic capacitor according to a first example embodiment of the present invention.

FIG. 2 is a front view depicting the example of the multilayer ceramic capacitor according to the first example embodiment of the present invention.

FIG. 3 is a plan view depicting the example of the multilayer ceramic capacitor according to the first example embodiment of the present invention.

FIG. 4 is a schematic sectional view along line IV-IV in FIG. 1.

FIG. 5 is a schematic sectional view along line V-V in FIG. 1.

FIG. 6 is a schematic sectional view along line VI-VI in FIG. 1.

FIG. 7 is a diagram for explaining operation and effects of the example of the multilayer ceramic capacitor according to the first example embodiment of the present invention.

FIG. 8 is an external perspective view depicting a multilayer ceramic capacitor that is an example of a multilayer ceramic capacitor according to another example embodiment of the present invention.

FIG. 9 is a schematic sectional view along line IX-IX in FIG. 8.

FIG. 10 is a schematic sectional view along line X-X in FIG. 8.

### DETAILED DESCRIPTION OF THE EXAMPLE EMBODIMENTS

Multilayer ceramic capacitors are described below as examples of the present invention in the present example embodiments.

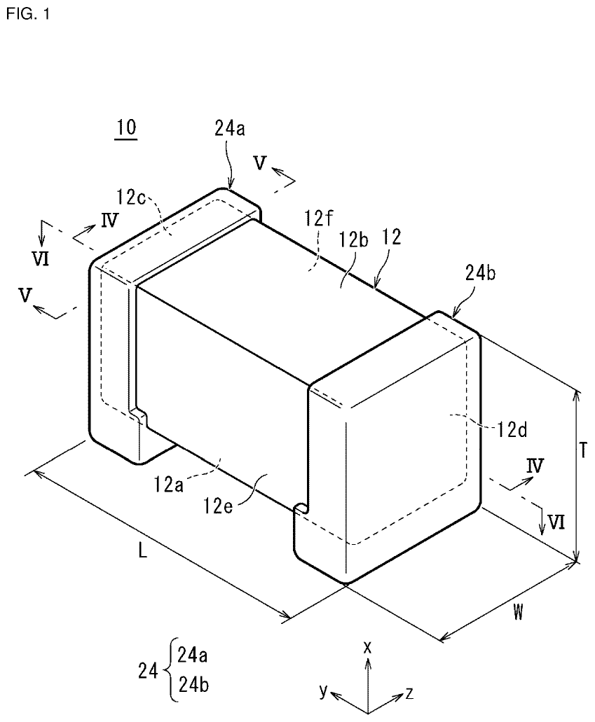

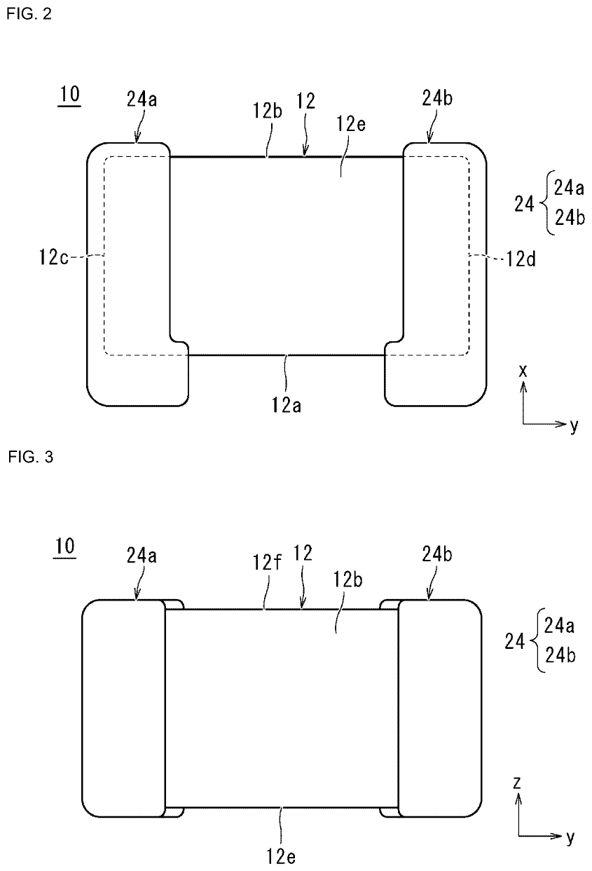

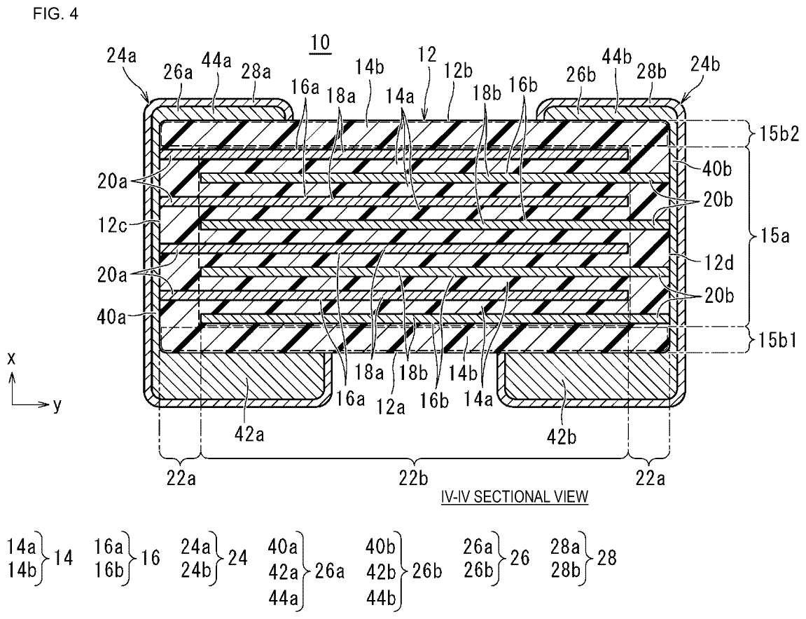

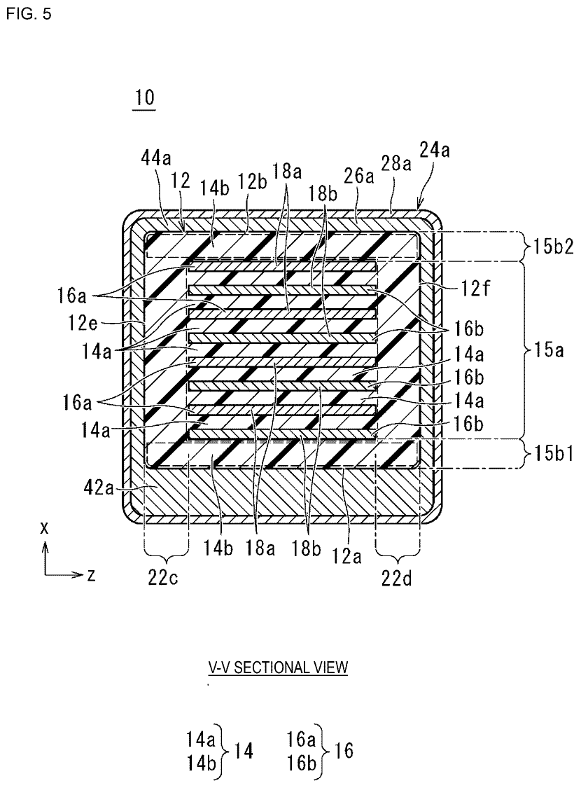

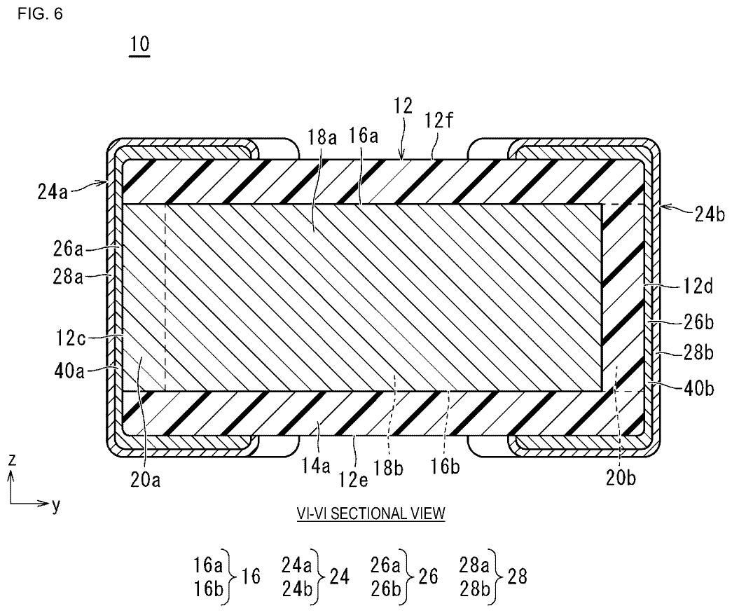

An example of a multilayer ceramic capacitor 10 according to a first example embodiment of the present invention is described. FIG. 1 is an external perspective view depicting the example of the multilayer ceramic capacitor according to the first example embodiment of the present invention. FIG. 2 is a front view depicting the example of the multilayer ceramic capacitor according to the first example embodiment of the present invention. FIG. 3 is a plan view depicting the example of the multilayer ceramic capacitor according to the first example embodiment of the present invention. FIG. 4 is a schematic sectional view along line IV-IV in FIG. 1. FIG. 5 is a schematic sectional view along line V-V in FIG. 1. FIG. 6 is a schematic sectional view along line VI-VI in FIG. 1.

The multilayer ceramic capacitor 10 includes a multilayer body 12 and outer electrodes 24. Each configuration is described below in order of the multilayer body 12 and the outer electrodes 24.

The multilayer body 12 includes a first surface 12a and a second surface 12b opposite to each other in a height direction x, a third surface 12c and a fourth surface 12d opposite to each other in a first direction y orthogonal to the height direction x, and a fifth surface 12e and a sixth surface 12f opposite to each other in a second direction z orthogonal to the height direction x and the first direction y. A direction that links the first surface 12a and the second surface 12b of the multilayer body 12 to each other is the height direction x. In the present example embodiment, the first surface 12a of the multilayer body 12 is the mounting surface side.

The multilayer body 12 has a rectangular or substantially rectangular parallelepiped shape. Further, it is preferable that corner portions and ridge line portions be rounded in the multilayer body 12. The ridge line portion refers to a portion at which two surfaces among the first surface 12a, the second surface 12b, the third surface 12c, the fourth surface 12d, the fifth surface 12e, and the sixth surface 12f intersect. Moreover, the corner portion refers to a portion at which adjacent three surfaces of the multilayer body 12 intersect. It is preferable that the ridge line portions and the corner portions be rounded. Rounding these portions can prevent chipping and cracking. When the ridge line portions and the corner portions are rounded, the surfaces excluding the ridge line portions and the corner portions may be flat. Further, concavities and convexities or the like may be formed in a portion of or an entirety of the first surface 12a and the second surface 12b, the third surface 12c and the fourth surface 12d, and the fifth surface 12e and the sixth surface 12f. The first surface 12a is the mounting surface side.

The multilayer body 12 includes a plurality of dielectric layers 14 and a plurality of inner electrodes 16. The dielectric layers 14 include inner dielectric layers 14a and outer dielectric layers 14b. Further, the inner electrodes 16 include first inner electrodes 16a and second inner electrodes 16b.

Moreover, the multilayer body 12 includes an inner layer portion 15a, a first outer layer portion 15b1 located on the side of the first surface 12a, and a second outer layer portion 15b2 located on the side of the second surface 12b.

The first outer layer portion 15b1 is located on the side of the first surface 12a of the multilayer body 12, and is an aggregate of the outer dielectric layers 14b located between the first surface 12a and the inner electrode 16 closest to the first surface 12a.

The second outer layer portion 15b2 is located on the side of the second surface 12b of the multilayer body 12, and is an aggregate of the outer dielectric layers 14b located between the second surface 12b and the inner electrode 16 closest to the second surface 12b.

Further, a region interposed between the first outer layer portion 15b1 and the second outer layer portion 15b2 is the inner layer portion 15a.

The inner layer portion 15a includes the first inner electrodes 16a each including one end exposed in the third surface 12c, the second inner electrodes 16b each including one end exposed in the fourth surface 12d, and the inner dielectric layers 14a.

The inner dielectric layers 14a include first regions 22a that cover one end that is not exposed in the third surface 12c or the fourth surface 12d in the first direction y in the first inner electrode 16a and the second inner electrode 16b, and a second region 22b that covers at least a portion of one surface of the first inner electrode 16a and the second inner electrode 16b in the lamination direction.

That is, the first regions 22a include a region between the first inner electrode 16a and the fourth surface 12d and a region between the second inner electrode 16b and the third surface 12c. The second region 22b covers at least a portion of the surface of the first inner electrode 16a and the second inner electrode 16b on the side of the first surface 12a.

It is preferable that the dielectric component included most in the first region 22a be the same kind of component as the dielectric component included most in the second region 22b. The dielectric component may include, but is not limited to, for example, components such as Ba, Ti, Ca, Zr, and Sr.

For example, when a large amount of CaTio₃ or CaZrO₃ is included as the dielectric component, it is possible to reduce the likelihood of dielectric breakdown that occurs between an end portion of the first inner electrode 16a in the first direction y and a second outer electrode 24b and between the first inner electrode 16a and the second inner electrode 16b. Moreover, the dielectric component is not limited thereto, and it is also possible to use SrTiO₃ or the like as a main component.

Further, it is preferable that the second region 22b include a material having a high dielectric constant, for example, BaTiO₃ or the like, in order to enhance the capacitance of the multilayer ceramic capacitor 10.

The number of laminated dielectric layers 14 is not particularly limited, but it is preferable that the number be five or more and 1000 or less including the first outer layer portion 15b1 and the second outer layer portion 15b2. Moreover, it is preferable that the thickness of the dielectric layer 14 be, for example, about 0.3 μm or more and about 6.0 μm or less.

The first outer layer portion 15b1 and the second outer layer portion 15b2 each include an insulating material.

In a case in which the first outer layer portion 15b1 and the second outer layer portion 15b2 include the same kind of dielectric material as the first regions 22a and the second region 22b of the inner dielectric layer 14a, the respective outer layer portions 15b1 and 15b2 may include a plurality of outer dielectric layers 14b, or may include the single outer dielectric layer 14b.

Further, the inner dielectric layer 14a and the outer dielectric layer 14b may include different components. For example, it is also possible that the inner dielectric layer 14a includes a material having a high dielectric constant compared with the outer dielectric layer 14b and the material of the outer dielectric layer 14b is changed to a material in which each of the moisture resistance, the weather resistance, and the strength is improved.

Moreover, the configuration is not limited thereto, and the first outer layer portion 15b1 and the second outer layer portion 15b2 may include a DLC film, or may include different kinds of insulating materials such as insulating resins.

As depicted in FIGS. 4 and 5, the inner electrodes 16 have the first inner electrodes 16a and the second inner electrodes 16b. The first inner electrodes 16a and the second inner electrodes 16b are alternately laminated, with the dielectric layer 14 interposed therebetween.

The first inner electrode 16a is disposed on a surface of the dielectric layer 14. The first inner electrode 16a includes a first opposite electrode portion 18a opposite to the second inner electrode 16b and a first extended electrode portion 20a that is located on one end side of the first inner electrode 16a and reaches the third surface 12c of the multilayer body 12 from the first opposite electrode portion 18a. An end portion of the first extended electrode portion 20a is extended to the third surface 12c and is exposed.

The shape of the first opposite electrode portion 18a of the first inner electrode 16a is not particularly limited, but it is preferable that the shape be a rectangular or substantially rectangular shape in plan view. However, a corner portion may be rounded in plan view, or the corner portion may be obliquely formed in plan view (tapered shape). Further, the shape may be a tapered shape in which an inclination is given in a direction toward either end portion in plan view.

The shape of the first extended electrode portion 20a of the first inner electrode 16a is not particularly limited, but it is preferable that the shape be a rectangular or substantially rectangular shape in plan view. However, a corner portion may be rounded in plan view, or the corner portion may be obliquely formed in plan view (tapered shape). Further, the shape may be a tapered shape in which an inclination is given in a direction toward either end portion in plan view.

The width of the first opposite electrode portion 18a of the first inner electrode 16a and the width of the first extended electrode portion 20a of the first inner electrode 16a may have the same width, or either one may have a smaller width.

The second inner electrode 16b is disposed on a surface of the dielectric layer 14 different from the dielectric layer 14 on which the first inner electrode 16a is disposed. The second inner electrode 16b has a second opposite electrode portion 18b opposite to the first inner electrode 16a and a second extended electrode portion 20b that is located on one end side of the second inner electrode 16b and reaches the fourth surface 12d of the multilayer body 12 from the second opposite electrode portion 18b. An end portion of the second extended electrode portion 20b is extended to the fourth surface 12d and is exposed.

The shape of the second opposite electrode portion 18b of the second inner electrode 16b is not particularly limited, but it is preferable that the shape be a rectangular or substantially rectangular shape in plan view. However, a corner portion may be rounded in plan view, or the corner portion may be obliquely formed in plan view (tapered shape). Further, the shape may be a tapered shape in which an inclination is given in a direction toward either end portion in plan view.

The shape of the second extended electrode portion 20b of the second inner electrode 16b is not particularly limited, but it is preferable that the shape be a rectangular or substantially rectangular shape in plan view. However, a corner portion may be rounded in plan view, or the corner portion may be obliquely formed in plan view (tapered shape). Further, the shape may be a tapered shape in which an inclination is given in a direction toward either end portion in plan view.

The width of the second opposite electrode portion 18b of the second inner electrode 16b and the width of the second extended electrode portion 20b of the second inner electrode 16b may have the same width, or either one may have a smaller width.

The first inner electrode 16a and the second inner electrode 16b can include, for example, an appropriate conductive material such as a metal like Ni, Cu, Ag, Pd, Au, or the like or an alloy including at least one kind of these metals like an Ag—Pd alloy or the like, but are not limited thereto.

The first inner electrode 16a and the second inner electrode 16b may include Sn. The including of Sn in the first inner electrode 16a and the second inner electrode 16b can alleviate electric field concentration on the interface between the inner electrode 16 and the dielectric layer 14. This leads to improvement in the reliability against a high-temperature load. In this case, Sn can sufficiently exhibit the effect even when being included in only either one inner electrode 16 of the first inner electrode 16a and the second inner electrode 16b.

When a region between the first inner electrode 16a and the fifth surface 12e and between the second inner electrode 16b and the fifth surface 12e is defined as a third region 22c and a region between the first inner electrode 16a and the sixth surface 12f and between the second inner electrode 16b and the sixth surface 12f is defined as a fourth region 22d, segregation of Si may exist between the inner electrodes 16 and the third region 22c and the fourth region 22d. This can improve the flexural strength of the multilayer ceramic capacitor 10.

In the present example embodiment, the first opposite electrode portion 18a of the first inner electrode 16a and the second opposite electrode portion 18b of the second inner electrode 16b are opposite to each other, with the dielectric layer 14 interposed therebetween. This generates electrostatic capacitance, and develops characteristics of the capacitor.

The number of laminated inner electrodes 16 is not particularly limited, but it is preferable that the number be five or more and 1000 or less. Moreover, it is preferable that the thickness of the inner electrode 16 be about 0.2 μm or more and about 2.0 μm or less, for example.

As depicted in FIGS. 1 to 6, the outer electrodes 24 are disposed on the side of the third surface 12c and the side of the fourth surface 12d in the multilayer body 12.

The outer electrodes 24 include underlying electrode layers 26 covering each of the side of the third surface 12c and the side of the fourth surface 12d in the multilayer body 12, and plated layers 28 covering the underlying electrode layers 26.

The outer electrodes 24 include a first outer electrode 24a and the second outer electrode 24b.

The first outer electrode 24a includes a first underlying electrode layer 26a that covers the side of the third surface 12c and a first plated layer 28a that covers the first underlying electrode layer 26a.

The second outer electrode 24b includes a second underlying electrode layer 26b that covers the side of the fourth surface 12d and a second plated layer 28b that covers the second underlying electrode layer 26b.

The first outer electrode 24a is disposed on the third surface 12c, a portion of the first surface 12a, a portion of the second surface 12b, a portion of the fifth surface 12e, and a portion of the sixth surface 12f in the multilayer body 12. In this case, the first outer electrode 24a is electrically connected to the first extended electrode portions 20a of the first inner electrodes 16a.

The first outer electrode 24a is formed such that the thickness on the side of the first surface 12a, which is a dimension along the height direction x, is larger than the thickness on the side of the second surface 12b depending on the shape of the underlying electrode layer 26 to be described later.

The second outer electrode 24b is disposed on the fourth surface 12d, a portion of the first surface 12a, a portion of the second surface 12b, a portion of the fifth surface 12e, and a portion of the sixth surface 12f in the multilayer body 12. In this case, the second outer electrode 24b is electrically connected to the second extended electrode portions 20b of the second inner electrodes 16b.

The second outer electrode 24b is formed such that the thickness on the side of the first surface 12a, which is the dimension along the height direction x, is larger than the thickness on the side of the second surface 12b depending on the shape of the underlying electrode layer 26 to be described later.

The underlying electrode layers 26 include the first underlying electrode layer 26a and the second underlying electrode layer 26b.

The first underlying electrode layer 26a is disposed to integrally cover each of the third surface 12c, a portion of the first surface 12a, a portion of the second surface 12b, a portion of the fifth surface 12e, and a portion of the sixth surface 12f in the multilayer body 12.

The second underlying electrode layer 26b is disposed to integrally cover each of the fourth surface 12d, a portion of the first surface 12a, a portion of the second surface 12b, a portion of the fifth surface 12e, and a portion of the sixth surface 12f in the multilayer body 12.

As depicted in FIG. 4, the first underlying electrode layer 26a includes a first connection portion 40a disposed on the third surface 12c, a first band portion 42a disposed on the first surface 12a, and a third band portion 44a disposed on the second surface 12b.

As depicted particularly in FIG. 4, the second underlying electrode layer 26b includes a second connection portion 40b disposed on the fourth surface 12d, a second band portion 42b disposed on the first surface 12a, and a fourth band portion 44b disposed on the second surface 12b.

In the first underlying electrode layer 26a, a dimension BH1 of the first band portion 42a in the height direction x is larger than a dimension BH3 of the third band portion 44a in the height direction x (BH1>BH3).

In the second underlying electrode layer 26b, a dimension BH2 41 the second band portion 42b in the height direction x is larger than a dimension BH4 of the fourth band portion 44b in the height direction x (BH2>BH4).

The effect of reduction or prevention of “acoustic noise” is obtained at a higher degree when, in the underlying electrode layers 26, the dimension BH1 of the first band portion 42a and the dimension BH2 of the second band portion 42b are larger to a greater extent than the dimension BH3 of the third band portion 44a and the dimension BH4 of the fourth band portion 44b. However, setting the respective dimensions of the dimension BH1 of the first band portion 42a and the dimension BH2 of the second band portion 42b too large results in a large dimension of the whole of the multilayer ceramic capacitor 10 in the height direction x, and thus lowers the flexibility in mounting.

Thus, it is preferable that the dimension BH1 of the first band portion 42a and the dimension BH2 of the second band portion 42b be larger by about 70 μm or more and about 270 μm or less than the dimension BH3 of the third band portion 44a and the dimension BH4 of the fourth band portion 44b, for example.

Further, the dimension BH1 of the first band portion 42a is larger than the thickness in the first direction y concerning a central portion of the first connection portion 40a in the height direction x, and the dimension BH2 of the second band portion 42b is larger than the thickness in the first direction y concerning a central portion of the second connection portion 40b in the height direction x.

Moreover, it is preferable that a length BL1 of the first band portion 42a in the first direction y be equal to or longer than a length BL3 of the third band portion 44a in the first direction y, and it is preferable that a length BL2 of the second band portion 42b in the first direction y be equal to or longer than a length BL4 of the fourth band portion 44b in the first direction y. This can further increase the anchoring area between the first band portion 42a and the second band portion 42b and a solder at the time of mounting, and improve the stability.

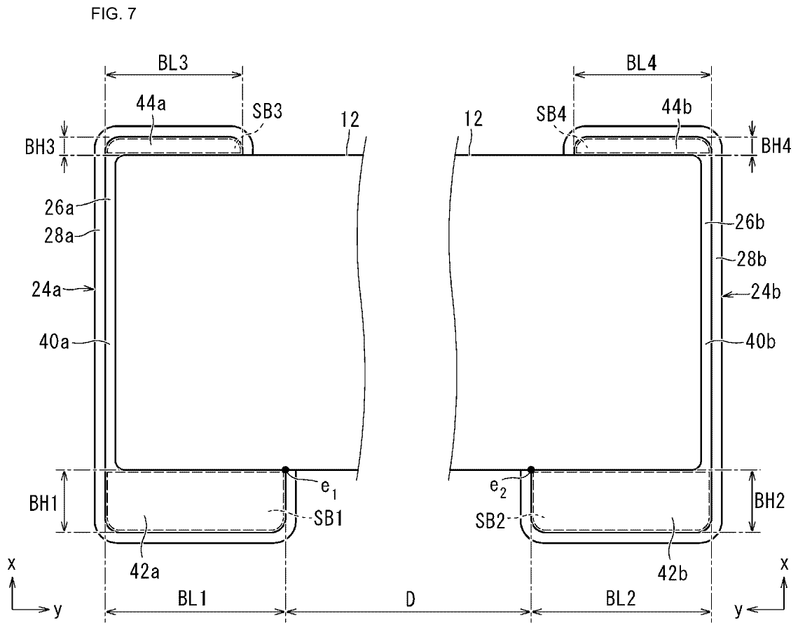

In the multilayer ceramic capacitor 10, as depicted in FIG. 7, it is preferable that, in the first direction y, a distance of about 300 μm or longer, for example, be set as a distance D between an end edge portion e₁ nearer to the center of the multilayer body 12 in the first band portion 42a of the first underlying electrode layer 26a and an end edge portion e₂ nearer to the center of the multilayer body 12 in the second band portion 42b of the second underlying electrode layer. If the distance D is too short, there is a possibility that the first outer electrode 24a and the second outer electrode 24b are electrically connected to each other due to electrochemical migration or the like. Thus, the distance D equal to or longer than about 300 μm, for example, can reduce the possibility.

Concerning the positions of the end edge portion e₁ nearer to the center of the multilayer body 12 in the first band portion 42a and the end edge portion e₂ nearer to the center of the multilayer body 12 in the second band portion 42b, a region closer to the side of the first surface 12a of the multilayer body 12 is sometimes located nearer to the center of the multilayer body 12. At this time, the distance D in the first direction y between the first band portion 42a and the second band portion 42b is defined on the basis of the distance between the innermost points in the respective band portions 42a and 42b. In other words, the length BL1 of the first band portion 42a and the length BL2 of the second band portion 42b on the side closer to the first surface 12a of the multilayer body 12 are longer than those on the mounting surface side. This increases the anchoring area between the first band portion 42a and the second band portion 42b and the multilayer body 12 on the mounting surface side.

Further, in the multilayer ceramic capacitor 10, as depicted in FIG. 7, it is preferable that, as viewed in the second direction z, an area SB1 of the first band portion 42a, that is, the product of the dimension BL1 in the first direction y and the dimension BH1 in the height direction x concerning the first band portion 42a (BL1×BH1), be larger than an area SB3 of the third band portion 44a, that is, the product of the dimension BL3 in the first direction y and the dimension BH3 in the height direction x concerning the third band portion 44a (BL3×BH3), (SB1>SB3).

Similarly, as depicted in FIG. 7, it is preferable that, as viewed in the second direction z, an area SB2 of the second band portion 42b, that is, the product of the dimension BL2 in the first direction y and the dimension BH2 in the height direction x concerning the second band portion 42b (BL2×BH2), be larger than an area SB4 of the fourth band portion 44b, that is, the product of the dimension BL4 in the first direction y and the dimension BH4 in the height direction x concerning the fourth band portion 44b (BL4×BH4), (SB2>SB4).

This allows the areas of the first band portion 42a and the second band portion 42b to be comparatively large. Therefore, at the time of mounting, the anchoring area between the first band portion 42a and the second band portion 42b and a solder increases. Thus, the stability of the multilayer ceramic capacitor 10 at the time of mounting can be further improved.

In the multilayer ceramic capacitor 10, the dimension in each of the height direction x and the first direction y concerning the first band portion 42a, the second band portion 42b, the third band portion 44a, and the fourth band portion 44b can be measured in the following manner.

The dimension of each band portion in the height direction x is measured as follows. In the direction that links the third surface 12c and the fourth surface 12d of the multilayer body 12 (first direction y), section polishing is executed in the second direction z of the multilayer ceramic capacitor 10 to a surface of ½W, and a polished surface (LT-section) is exposed. Then, by using a microscope (made by Olympus Corporation, model number: BX-51) to which a digital camera (made by Olympus Corporation, model number: DP22) for the microscope is connected, the dimension in the height direction x at a central portion along the first direction y is measured at a total magnification of 100 times or more and 500 times or less concerning each of the first band portion 42a, the second band portion 42b, the third band portion 44a, and the fourth band portion 44b. Moreover, measurement is executed in a plurality of polished surfaces orthogonal to each other, and a measurement value of the dimension in the height direction x concerning each band portion in each polished surface is obtained. Then, the dimension of each band portion in the height direction x is defined as an average value of these measurement values.

On the basis of observation of the above-described polished surface, the dimension in the first direction y is measured on the basis of the boundary between the first connection portion 40a and the first band portion 42a or the third band portion 44a or the boundary between the second connection portion 40b and the second band portion 42b or the fourth band portion 44b.

The measurement is executed as follows in a case in which the contours of the multilayer body 12 are rounded and the boundary between the first connection portion 40a and the first band portion 42a or the third band portion 44a or the boundary between the second connection portion 40b and the second band portion 42b or the fourth band portion 44b is observed as an obscure boundary.

Specifically, in the multilayer body 12, the first inner electrode 16a or the second inner electrode 16b existing at a position closest to the first surface 12a is selected, and the end portion exposed in the third surface 12c or the fourth surface 12d in the first extended electrode portion 20a or the second extended electrode portion 20b included in either inner electrode selected is specified. By defining this end portion as the boundary between the first connection portion 40a and the first band portion 42a or the boundary between the second connection portion 40b and the second band portion 42b and measuring the dimension in the first direction y, the respective dimensions of the first band portion 42a and the second band portion 42b in the first direction y are obtained.

Similarly, in the multilayer body 12, the first inner electrode 16a or the second inner electrode 16b existing at a position closest to the second surface 12b is selected, and the end portion exposed in the third surface 12c or the fourth surface 12d in the first extended electrode portion 20a or the second extended electrode portion 20b included in either inner electrode selected is specified. By defining this end portion as the boundary between the first connection portion 40a and the third band portion 44a or the boundary between the second connection portion 40b and the fourth band portion 44b and measuring the dimension in the first direction y, the respective dimensions of the third band portion 44a and the fourth band portion 44b in the first direction y are obtained.

It is preferable that the underlying electrode layer 26 include mainly Cu. However, the underlying electrode layer 26 may include other metal components and a glass component besides Cu. As other metal components, for example, Mg, Cr, Sr, Al, Na, Fe, and the like can be used. Further, as the glass component, for example, an oxide of Ba, Sr, Si, Ca, Zn, Al, B, or the like can be used.

The underlying electrode layer 26 can be a baked layer. The baked layer is a layer obtained by applying conductive paste including glass and a metal to the multilayer body and baking the paste. The baked layer may be a layer obtained by simultaneous firing with the inner electrodes 16, or may be baked after firing the inner electrodes 16. The baked layer may include a plurality of layers.

It is preferable that the dimension BH3 of the third band portion 44a and the dimension BH4 of the fourth band portion 44b fall within a range of, for example, about 10 μm to about 40 μm inclusive. Moreover, it is preferable that the dimensions in the first direction y, that is, the lengths in the first direction, concerning the third band portion 44a and the fourth band portion 44b be equal to or larger than about 200 μm, for example. The distance in the first direction y between the third band portion 44a and the fourth band portion 44b is defined on the basis of the distance between the innermost points in the respective band portions 44a and 44b.

The plated layers 28 include the first plated layer 28a and the second plated layer 28b.

The first plated layer 28a is disposed to cover the first underlying electrode layer 26a.

The second plated layer 28b is disposed to cover the second underlying electrode layer 26b.

Although the plated layer 28 may include a single layer, it is particularly preferable that the plated layer 28 include at least two layers. For example, a multilayer structure made by nickel plating and tin plating in that order from the side of the multilayer body 12 may be used. Moreover, in a case of a three-layer structure, a multilayer structure made by tin plating, nickel plating, and tin plating in that order from the side of the multilayer body 12 may be used. The nickel plating can prevent the inner electrodes 16 from being eroded by a solder. The tin plating can improve the mountability.

Further, the plated layer 28 is not limited thereto, and it is preferable for the plated layer 28 to include, for example, at least one kind of metal selected from Cu, Ni, Sn, Pb, Au, Ag, Pd, Bi, Zn, and the like or an alloy including this metal. It is preferable for the plated layer 28 not to include glass. It is preferable that the percentage of the metal per unit volume in the plated layer be equal to or higher than 99 volume%, for example.

It is preferable that the thickness per one plated layer of the plated layer 28 be about 1.0 μm or more and about 15.0 μm or less, for example.

The dimension of the multilayer ceramic capacitor 10 in the first direction n y is defined as an L-dimension, and the dimensions thereof in the height direction x and the second direction z are defined as a T-dimension and a W-dimension, respectively.

It is preferable that the dimensions of the multilayer ceramic capacitor 10 be as follows: the L-dimension in the first direction y is 1.0 mm or more and 3.2 mm or less; the T-dimension in the height direction x is 0.55 mm or more and 2.1 mm or less; and the W-dimension in the second direction z is 0.5 mm or more and 1.6 mm or less, for example.

In the multilayer ceramic capacitor 10 according to the first example embodiment depicted in FIG. 1, the dimension BH1 of the first band portion 42a is larger than the dimension BH3 of the third band portion 44a in the first underlying electrode layer 26a of the underlying electrode layers 26, and the dimension BH2 of the second band portion 42b is larger than the dimension BH4 of the fourth band portion 44b in the second underlying electrode layer 26b. Due to this, in mounting of the multilayer ceramic capacitor 10, by disposing the outer electrodes 24 such that the side including the first band portion 42a of the first underlying electrode layer 26a and the second band portion 42b of the second underlying electrode layer 26b located on the side of the first surface 12a is opposite to the mounting surface side, the inner layer portion 15a of the multilayer body 12 is made remote from a mounting board compared with a case in which the side of the second surface 12b is set on the mounting surface side. This reduces the influence of vibration of the multilayer body 12 on the board, and reduces or prevents the “acoustic noise.”

Moreover, with the multilayer ceramic capacitor 10, a component independent of the multilayer ceramic capacitor 10, such as a bump, is not used for the outer electrode 24. Thus, it is possible to reduce or prevent the occurrence of a trouble attributed to use of this separate member, such as position misalignment or rotation in position alignment of the multilayer ceramic capacitor 10 or the occurrence of a defect in the multilayer ceramic capacitor 10 due to the influence of heat treatment or the like.

Therefore, the occurrence of the “acoustic noise” can be reduced or prevented by the multilayer ceramic capacitor alone.

A non-limiting example of a manufacturing method for a multilayer ceramic capacitor that is an example of the multilayer ceramic capacitor according to the above-described example embodiment is described below.
(1) A dielectric sheet and conductive paste for the inner electrode are prepared. The dielectric sheet and the conductive paste for the inner electrode include a binder (for example, publicly-known organic binder) and an organic solvent (for example, publicly-known organic solvent).
(2) Next, the conductive paste for the inner electrode is applied onto the dielectric sheet with a predetermined pattern by, for example, screen printing or gravure printing to form an inner electrode pattern. As for the dielectric sheet, a dielectric sheet for the outer layer on which the inner electrode pattern is not printed is also fabricated.
(3) A predetermined number of dielectric sheets for the outer layer on which the inner electrode pattern is not formed are stacked, and the dielectric sheets on which the inner electrode pattern corresponding to the first inner electrode 16a is formed and the dielectric sheets on which the inner electrode pattern corresponding to the second inner electrode 16b is formed are alternately stacked over the dielectric sheets for the outer layer. Moreover, a predetermined number of dielectric sheets for the outer layer on which the inner electrode pattern is not formed are stacked over the dielectric sheets with the inner electrode pattern, to thereby fabricate a multilayer sheet. Further, the multilayer sheet is pressed in the stacking direction by a measure such as isostatic press to fabricate a multilayer block.
(4) Subsequently, the multilayer block is cut into a predetermined size to cut out a multilayer chip. Then, wet barrel finishing may be executed to round corner portions and ridge line portions of the multilayer chip.
(5) Next, the multilayer chip is fired to fabricate the multilayer body 12. It is preferable that the firing temperature be 900° C. or more and 1400° C. or less although it depends on the ceramic and the material of the inner electrode 16.

Subsequently, the underlying electrode layers 26 are formed as baked layers. Conductive paste including a glass component and a metal component is applied to the third surface 12c and the fourth surface 12d of the multilayer body 12 by, for example, a dipping method to form connection portions and band portions. Then, the multilayer body 12 to which the conductive paste has been applied is dried at 100° C. or more and 300° C. or less.
(7) In the multilayer body 12 after the drying, the conductive paste is applied to first surface 12a and the second surface 12b to form the respective band positions, the first band portion 42a, the second band portion 42b, the third band portion 44a, and the fourth band portion 44b, and adjust the thickness of them. Specifically, a method in which the conductive paste is pushed out from a slit plate to be applied is used. At this time, each dimension of each band portion can be controlled on the basis of the amount of conductive paste and the strength in the pushing-out thereof from the slit plate.

Further, the method for forming the band portions is not limited to the above-described method. The respective band positions may be formed by a method in which the multilayer bodies 12 to which the conductive paste has been applied are arranged and the conductive paste is applied onto the multilayer bodies 12 by, for example, screen printing or the like. At this time, each band portion having desired dimensions can be formed by controlling the size of a through-hole of a masking jig or the like and the amount of conductive paste.
(8) The multilayer body 12 obtained in the step of the above-described (7) is fired under an environment at, for example, 700° C. or more and 900° C. or less, and thereby the underlying electrode layers 26 according to the present example embodiment can be formed. In this step, the step of baking the underlying electrode layers 26 can be executed at one time. Thus, a region partly excessively baked, or the like, does not occur, and a structural defect is reduced or prevented.
(9) The plated layers 28 are formed to be electrically connected to the underlying electrode layers 26. It is preferable to use electrolytic plating as plating treatment. It is preferable to use, for example, barrel plating as the plating method.

In the above-described manner, the multilayer ceramic capacitor 10 according to the example embodiment depicted in FIG. 1 can be manufactured.

With the manufacturing method for a multilayer ceramic capacitor according to the present example embodiment, the multilayer ceramic capacitor that can reduce or prevent the occurrence of the “acoustic noise” by the capacitor alone can be obtained.

A multilayer ceramic capacitor according to an example embodiment of the present invention, the multilayer ceramic capacitor 10 in which the lamination direction of the dielectric layers 14 and the inner electrodes 16 corresponds with the height direction x and is orthogonal to the mounting surface in the multilayer body 12 has been described as the example. However, a multilayer ceramic capacitor according to an example embodiment of the present invention may be, for example, a multilayer ceramic capacitor of a vertical type in which the lamination direction of dielectric layers and inner electrodes is parallel to the mounting surface.

Subsequently, an example of a multilayer ceramic capacitor 110 according to a second example embodiment of the present invention is described.

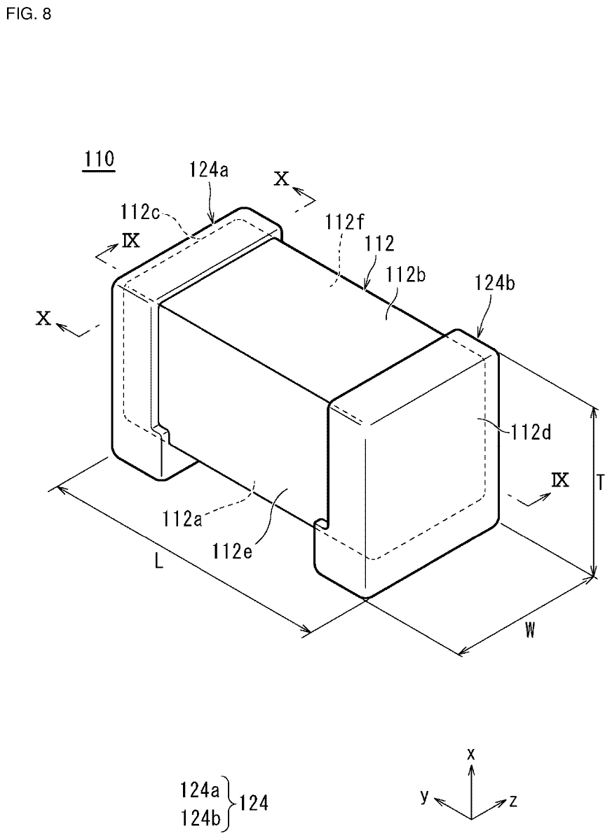

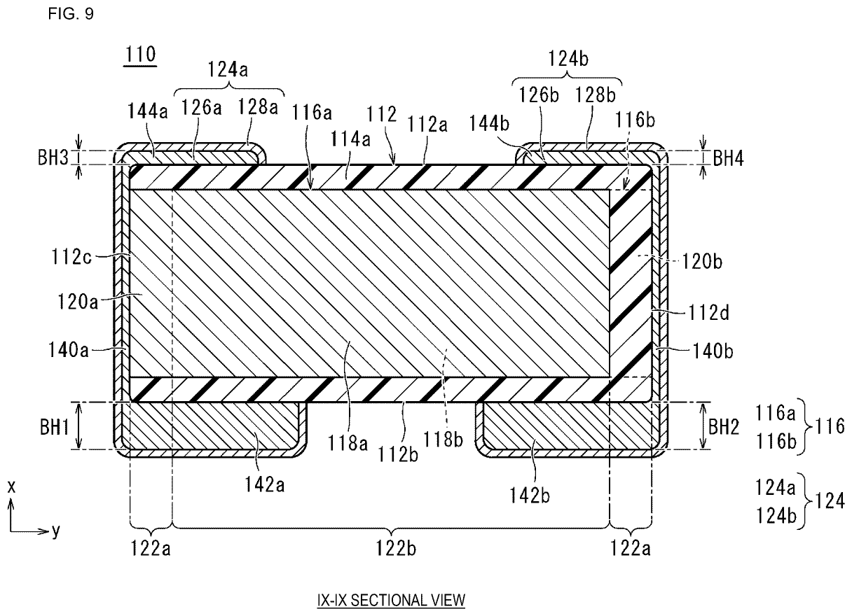

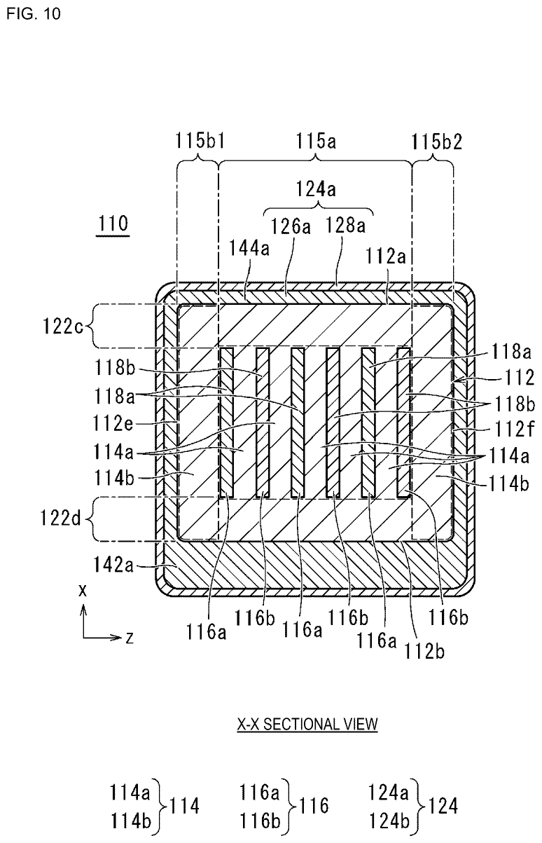

FIG. 8 is an external perspective view depicting a multilayer ceramic capacitor that is an example of a multilayer ceramic capacitor according to another example embodiment of the present invention. FIG. 9 is a schematic sectional view along line IX-IX in FIG. 8. FIG. 10 is a schematic sectional view along line X-X in FIG. 8. In the multilayer ceramic capacitor 110 according to the second example embodiment, the lamination direction of inner electrodes is the width direction (second direction z) differently from the multilayer ceramic capacitor 10 according to the first example embodiment.

The multilayer ceramic capacitor 110 includes a multilayer body 112 and outer electrodes 124 as depicted in the respective diagrams.

The multilayer body 112 includes a plurality of dielectric layers 114 and a plurality of inner electrodes 116 laminated along the second direction z. The multilayer body 112 includes a first surface 112a and a second surface 112b opposite to each other in the height direction x, a third surface 112c and a fourth surface 112d opposite to each other in the first direction y orthogonal to the height direction x, and a fifth surface 112e and a sixth surface 112f opposite to each other in the second direction z orthogonal to the height direction x and the first direction y. A direction that links the first surface 112a and the second surface 112b of the multilayer body 112 to each other is the height direction x.

The multilayer body 112 includes the dielectric layers 114 and the inner electrodes 116. The dielectric layers 114 include inner dielectric layers 114a and outer dielectric layers 114b. Further, the inner electrodes 116 have first inner electrodes 116a and second inner electrodes 116b.

Moreover, the multilayer body 112 includes an inner layer portion 115a, a first outer layer portion 115b1 located on the side of the fifth surface 112e, and a second outer layer portion 115b2 located on the side of the sixth surface 112f.

The first outer layer portion 115b1 is located on the side of the fifth surface 112e of the multilayer body 112, and is an aggregate of the outer dielectric layers 114b located between the fifth surface 112e and the inner electrode 116 closest to the fifth surface 112e.

The second outer layer portion 115b2 is located on the side of the sixth surface 112f of the multilayer body 112, and is an aggregate of the outer dielectric layers 114b located between the sixth surface 112f and the inner electrode 116 closest to the sixth surface 112f.

Further, a region interposed between the first outer layer portion 115b1 and the second outer layer portion 115b2 is the inner layer portion 115a.

The inner layer portion 115a includes the first inner electrodes 116a each having one end exposed in the third surface 112c, the second inner electrodes 116b each having one end exposed in the fourth surface 112d, and the inner dielectric layers 114a.

The inner dielectric layers 114a include first regions 122a that cover one end that is not exposed in the third surface 112c or the fourth surface 112d in the first direction y in the first inner electrode 116a and the second inner electrode 116b, and a second region 122b that covers at least a portion of one surface of the first inner electrode 116a and the second inner electrode 116b in the lamination direction.

As depicted in FIGS. 9 and 10, the inner electrodes 116 include the first inner electrodes 116a and the second inner electrodes 116b. The first inner electrodes 116a and the second inner electrodes 116b are alternately laminated, with the dielectric layer 114 interposed therebetween.

The first inner electrode 116a is disposed on a surface of the dielectric layer 114. The first inner electrode 116a includes a first opposite electrode portion 118a opposite to the second inner electrode 116b and a first extended electrode portion 120a that is located on one end side of the first inner electrode 116a and reaches the third surface 112c of the multilayer body 12 from the first opposite electrode portion 118a. An end portion of the first extended electrode portion 120a is extended to the third surface 112c and is exposed.

The second inner electrode 116b is disposed on a surface of the dielectric layer 114 different from the dielectric layer 114 on which the first inner electrode 116a is disposed. The second inner electrode 116b includes a second opposite electrode portion 118b opposite to the first inner electrode 116a and a second extended electrode portion 120b that is located on one end side of the second inner electrode 116b and reaches the fourth surface 112d of the multilayer body from the second opposite electrode portion 118b. An end portion of the second extended electrode portion 120b is extended to the fourth surface 112d and is exposed.

When a region between the first inner electrode 116a and the first surface 112a and between the second inner electrode 116b and the first surface 112a is defined as a third region 122c and a region between the first inner electrode 116a and the second surface 112b and between the second inner electrode 116b and the second surface 112b is defined as a fourth region 122d, segregation of Si may exist between the inner electrodes 116 and the third region 122c and the fourth region 122d. This can improve the flexural strength of the multilayer ceramic capacitor 110.

In the present example embodiment, the first opposite electrode portion 118a of the first inner electrode 116a and the second opposite electrode portion 118b of the second inner electrode 116b are opposite to each other, with the inner dielectric layer 114a interposed therebetween. This forms electrostatic capacitance, and develops characteristics of the capacitor.

As depicted in FIGS. 8 to 10, the outer electrodes 124 are disposed on the side of the third surface 112c and the side of the fourth surface 112d in the multilayer body 112.

The outer electrodes 124 include underlying electrode layers 126 covering each of the side of the third surface 112c and the side of the fourth surface 112d in the multilayer body 112, and plated layers 128 covering the underlying electrode layers 126.

The outer electrodes 124 include a first outer electrode 124a and a second outer electrode 124b.

The first outer electrode 124a includes a first underlying electrode layer 126a that covers the side of the third surface 112c and a first plated layer 128a that covers the first underlying electrode layer 126a.

The second outer electrode 124b includes a second underlying electrode layer 126b that covers the side of the fourth surface 112d and a second plated layer 128b that covers the second underlying electrode layer 126b.

The first outer electrode 124a is disposed on the third surface 112c, a portion of the first surface 112a, a portion of the second surface 112b, a portion of the fifth surface 112e, and a portion of the sixth surface 112f in the multilayer body 112. In this case, the first outer electrode 124a is electrically connected to the first inner electrodes 116a.

The second outer electrode 124b is disposed on the fourth surface 112d, a portion of the first surface 112a, a portion of the second surface 112b, a portion of the fifth surface 112e, and a portion of the sixth surface 112f in the multilayer body 112. In this case, the second outer electrode 124b is electrically connected to the second inner electrodes 116b.

The underlying electrode layers 126 include the first underlying electrode layer 126a and the second underlying electrode layer 126b.

The first underlying electrode layer 126a is disposed to integrally cover each of the third surface 112c, a portion of the first surface 112a, a portion of the second surface 112b, and a portion of the fifth surface 112e and the sixth surface 112f in the multilayer body 112.

The second underlying electrode layer 126b is disposed to integrally cover each of the fourth surface 112d, a portion of the first surface 112a, a portion of the second surface 112b, and a portion of the fifth surface 112e and the sixth surface 112f in the multilayer body 112.

As depicted in FIG. 9, the first underlying electrode layer 126a includes a first connection portion 140a disposed on the third surface 112c, a first band portion 142a disposed on the first surface 112a, and a third band portion 144a disposed on the second surface 112b.

As depicted in FIG. 9, the second underlying electrode layer 126b includes a second connection portion 140b disposed on the fourth surface 112d, a second band portion 142b disposed on the first surface 112a, and a fourth band portion 144b disposed on the second surface 112b.

In the first underlying electrode layer 126a, the dimension BH1 of the first band portion 142a in the height direction x is larger than the dimension BH3 of the third band portion 144a in the height direction x (BH1>BH3).

In the second underlying electrode layer 126b, the dimension BH2 of the second band portion 142b in the height direction x is larger than the dimension BH4 of the fourth band portion 144b in the height direction x (BH2>BH4).

The multilayer ceramic capacitor 110 according to the second example embodiment depicted in FIG. 8 provides effects similar to those of the multilayer ceramic capacitor 10 depicted in FIG. 1.

Specifically, in mounting multilayer ceramic capacitor 110, by disposing the outer electrodes 124 such that the side including the first underlying electrode layer 126a and the second underlying electrode layer 126b located on the side of the first surface 112a is opposite to the mounting surface side, the inner layer portion 115a of the multilayer body 112 is made remote from a mounting board compared with a case in which the side of the second surface 112b is set on the mounting surface side. This reduces the influence of vibration of the multilayer body 112 on the board, and reduces or prevents the “acoustic noise.”

Concerning the shapes, the materials, and the other configurations of the multilayer body 112, the inner electrode 116, and the outer electrode 124, various changes similar to those described concerning the above-described multilayer ceramic capacitor 10 may be added.

Although the example embodiments of the present invention are disclosed in the preceding description as described above, the present invention is not limited thereto.

That is, various changes can be added to the example embodiments and the respective modifications described above concerning a mechanism, a shape, a material, a quantity, a position, an arrangement, or the like without departing from the technical idea of the present invention and the scope of the object thereof, and they are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a first surface and a second surface opposite to each other in a height direction, a third surface and a fourth surface opposite to each other in a first direction orthogonal to the height direction, and a fifth surface and a sixth surface opposite to each other in a second direction orthogonal to the height direction and the first direction;
a first outer electrode on the third surface, the first surface, the second surface, the fifth surface, and the sixth surface of the multilayer body; and
a second outer electrode on the fourth surface, the first surface, the second surface, the fifth surface, and the sixth surface of the multilayer body; wherein
the first outer electrode includes:
a first underlying electrode layer; and
a first plated layer on the first underlying electrode layer;
the second outer electrode includes:
a second underlying electrode layer; and
a second plated layer on the second underlying electrode layer;
the first underlying electrode layer includes:
a first connection portion on the third surface;
a first band portion on the first surface; and
a third band portion on the second surface;
the second underlying electrode layer includes:
a second connection portion on the fourth surface;
a second band portion on the first surface; and
a fourth band portion on the second surface;
a dimension of the first band portion in the height direction is larger than a dimension of the third band portion in the height direction; and
a dimension of the second band portion in the height direction is larger than a dimension of the fourth band portion in the height direction.

2. The multilayer ceramic capacitor according to claim 1, wherein, as viewed in the second direction:
an area of the first band portion is larger than an area of the third band portion; and
an area of the second band portion is larger than an area of the fourth band portion.

3. The multilayer ceramic capacitor according to claim 1, wherein, as viewed in the first direction:
a dimension of the first band portion is larger than a dimension of the third band portion; and
a dimension of the second band portion is larger than a dimension of the fourth band portion.

4. The multilayer ceramic capacitor according to claim 1, wherein a distance in the first direction between an edge portion nearer to a center of the multilayer body in the first band portion and an edge portion nearer to the center of the multilayer body in the second band portion is equal to or longer than about 300 μm.

5. The multilayer ceramic capacitor according to claim 1, wherein a main component of a material of the first underlying electrode layer and the second underlying electrode layer is Cu.

6. The multilayer ceramic capacitor according to claim 1, wherein a distance in the first direction between an edge portion nearer to a center of the multilayer body in the first band portion and an edge portion nearer to the center of the multilayer body in the second band portion is shorter than a distance in the first direction between an edge portion nearer to a center of the multilayer body in the third band portion and an edge portion nearer to the center of the multilayer body in the fourth band portion.

7. The multilayer ceramic capacitor according to claim 1, wherein a length of the first band portion in the first direction is equal to or longer than a length of the third band portion in the first direction.

8. The multilayer ceramic capacitor according to claim 7, wherein a length of the second band portion in the first direction is equal to or longer than a length of the fourth band portion in the first direction.

9. The multilayer ceramic capacitor according to claim 1, wherein the dimension of the first band portion is larger by about 70 μm or more and about 270 μm or less than the dimension of the third band portion.

10. The multilayer ceramic capacitor according to claim 9, wherein the dimension of the second band portion is larger by about 70 μm or more and about 270 μm or less than the dimension of the fourth band portion.

11. The multilayer ceramic capacitor according to claim 1, wherein the dimension of the first band portion is larger than a thickness in the first direction of a central portion of the first connection portion in the height direction.

12. The multilayer ceramic capacitor according to claim 11, wherein the dimension of the second band portion is larger than a thickness in the first direction of a central portion of the second connection portion in the height direction.

13. The multilayer ceramic capacitor according to claim 1, wherein a length of the first band portion on a side closer to the first surface of the multilayer body is longer than a length of the first band portion on a mounting surface side of the multilayer body.

14. The multilayer ceramic capacitor according to claim 13, wherein a length of the second band portion on a side closer to the first surface of the multilayer body is longer than a length of the second band portion on a mounting surface side of the multilayer body.

15. The multilayer ceramic capacitor according to claim 1, wherein the multilayer body further includes a plurality of inner electrodes stacked in the height direction.

16. The multilayer ceramic capacitor according to claim 1, wherein the multilayer body further includes a plurality of inner electrodes stacked in the second direction.

17. The multilayer ceramic capacitor according to claim 1, wherein the dimension of the third band portion is within a range of about 10 μm to about 40 μm inclusive.

18. The multilayer ceramic capacitor according to claim 17, wherein the dimension of the fourth band portion is within a range of about 10 μm to about 40 μm inclusive.

19. The multilayer ceramic capacitor according to claim 1, wherein a length in the first direction of the third band portion is equal to or larger than about 200 μm.

20. The multilayer ceramic capacitor according to claim 19, wherein a length in the first direction of the fourth band portion is equal to or larger than about 200 μm.
